(19) United States
(12) Patent Application Publication
(10) Pub. No.: US 2007/0091557 A1
(43) Pub. Date: Apr. 26, 2007

(54) Apparatus for holding a portable electronic device with an integrated cable holder

(75) Inventors: Sangbeom Kim, Durham, NC (US); Elliott Hsu, Raleigh, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/254,892

(22) Filed: Oct. 20, 2005

(51) Int. Cl. G06F 1/16

(52) U.S. Cl. 361/683

(57) ABSTRACT

An apparatus for holding a portable electronic device and connecting the portable electronic device to an accessory includes a holding member includes a first connector, a second connector configured to releasably attach to the first connector, and an integrated cable holder configured to hold a cable that is adapted to connect to the portable electronic device.

### FIELD OF THE INVENTION

The present invention relates to portable electronic devices, and in particular to wired accessories for portable electronic devices.

### BACKGROUND

Wired accessories are commonly available for portable electronic devices, such as mobile telephones. For example, a number of portable electronic devices, such as mobile telephones, portable radios and CD players, MP3 players, and even personal digital assistants (PDAs) include 2.5 mm audio jack connectors for connecting earphones that may be used, for example, to listen to music and/or to hear a remote party in a telephone call.

Commonly, lightweight earbuds (i.e., earphones that fit in the user's ear and are not connected to a common support frame that fits over the head) are used instead of more bulky headphones. However, lightweight earbuds may still be connected to the portable electronic device by long cables. Typically, the length of the earbud cables is chosen to be long enough to be used by both tall and short users.

In choosing a length of the earbud cables, designers may also take into account that the portable electronic device may be held in the user's hand, carried in a user's purse or pocket, or may be worn on a user's belt or arm or elsewhere on the user's body. Thus, a designer may choose to make the earbud cables long enough to be carried, for example, in the hand of a tall user. In that case, the cables may be far longer than necessary for a relatively short user and/or a user who intends to wear the portable electronic device on his or her arm or elsewhere in relatively close proximity to the head. The result is that many users must put up with an annoying amount of excess wiring that may hang behind or in front of them, and/or that may flap around when the user is engaged in physical activities, such as walking, jogging, cycling, rollerblading, etc. Even worse, the excess wiring may pull on the lightweight earbuds during such activities, and may even pull the earbuds out of the user's ear.

Despite these shortcomings, many users prefer to use lightweight wired earbuds instead of wireless solutions, such as Bluetooth wireless headsets, due to the relative expense of such devices and/or the difficulty of keeping such devices securely attached to the ear while engaging in physical activities.

### SUMMARY

An apparatus for holding a portable electronic device and connecting the portable electronic device to an accessory according to some embodiments of the invention includes a holding member that includes a first connector, a second connector configured to releasably attach to the first connector, and an integrated cable holder. In some embodiments, the apparatus may include a retractable cable in the integrated cable holder.

The first connector and the second connector may be generally cylindrical in shape. The second connector may be insertable into the first connector, and/or the first connector may be insertable into the second connector.

The first connector may have an inner diameter and the second connector may have an outer diameter that is smaller than the inner diameter of the first connector. The first connector may include at least one retaining member extending inwardly from an inner surface thereof an defining at least one slot therein, and the second connector may include at least one tab extending outwardly from an outer surface thereof, such that when the first connector and the second connector are in a first radial orientation, the tab is configured to fit into the slot, and when the first connector and the second connector are in a second radial orientation, the tab is held in place against longitudinal motion by the retaining member.

The first connector may include an integrated cable clip.

The first connector may include a cylinder having opposing ends and a pair of lips disposed at the respective opposing ends of the first connector. The cable may be at least partially wrapped around the first connector between the pair of lips.

The apparatus may further include a holster portion connected to the second connector and configured to receive the portable electronic device.

The second connector may be configured to be attached directly to a portable electronic device.

The cable holder may include an integrated retractable cable configured to connect to the portable electronic device.

The second connector may have an inner diameter and the first connector may have an outer diameter that is smaller than the inner diameter of the second connector. The second connector may include at least one retaining member extending inwardly from an inner surface thereof an defining at least one slot therein, and the first connector may include at least one tab extending outwardly from an outer surface thereof, such that when the first connector and the second connector are in a first radial orientation, the tab is configured to fit into the slot and when the first connector and the second connector are in a second radial orientation, the tab is held in place against longitudinal motion by the retaining member.

An apparatus for holding a portable electronic device according to further embodiments of the invention includes an armband includes a generally cylindrical first connector having an inner diameter and an outer diameter and having opposing ends and a pair of circumferential lips disposed at opposing ends of the first connector such that a cable may be at least partially wound around the first connector between the pair of lips, and a holster portion configured to hold the portable electronic device, the holster portion includes a generally cylindrical second connector having an outer diameter smaller than the inner diameter of the first connector and configured to be insertable into the first connector and to releasably attach to the first connector. The first connector may include at least one retaining member extending inwardly from an inner surface thereof and the second connector may include at least one tab extending outwardly from an outer surface thereof that is configured to releasably engage the at least one retaining member.

The first connector may include three retaining members extending inwardly from an inner surface thereof and arranged at spaced radial intervals to thereby define three spaces between the three retaining members, and the second connector may include three tabs extending outwardly from an outer surface thereof and arranged at spaced radial intervals such that the three tabs may pass within the three spaces between the three retaining when the second connector is inserted into the first connector.

The first connector may include an integrated retractable cable configured to connect to the portable electronic device.

An apparatus for holding a portable electronic device according to further embodiments of the invention includes a holster portion configured to hold the portable electronic device. The holster portion that includes a generally cylindrical first connector having an inner diameter and an outer diameter and having opposing ends and a pair of circumferential lips disposed at opposing ends of the first connector such that a cable may be at least partially wound around the first connector between the pair of lips, and an armband includes a generally cylindrical second connector having an outer diameter smaller than the inner diameter of the first connector and configured to be insertable into the first connector and to releasably attach to the first connector. The first connector may include at least one retaining member extending inwardly from an inner surface thereof, and the second connector may include at least one tab extending outwardly from an outer surface thereof that is configured to releasably engage the at least one retaining member. The first connector may include an integrated retractable cable configured to connect to the portable electronic device.

In particular embodiments, the first connector may include three retaining members extending inwardly from an inner surface thereof and arranged at spaced radial intervals to thereby define three spaces between the three retaining members, and the second connector may include three tabs extending outwardly from an outer surface thereof and arranged at spaced radial intervals such that the three tabs may pass within the three spaces between the three retaining members when the second connector is inserted into the first connector.

### DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic view of portable electronic device;

FIG. 2 is an exploded perspective view of an apparatus according to embodiments of the invention including an armband, first and second connectors, and a portable electronic device;

FIG. 3A is a perspective view of a first connector according to embodiments of the invention;

FIG. 3B is a perspective view of a second connector according to embodiments of the invention;

FIGS. 4A and 4B are front and side views, respectively, of an armband and first connector according to embodiments of the invention;

FIG. 5 is a schematic front view of a portable electronic device in locked and unlocked positions according to embodiments of the invention;

FIG. 6 is a schematic side view of a portable electronic device in a holster according to embodiments of the invention;

FIGS. 7 and 8 are pictorial views illustrating an apparatus according to embodiments of the invention in use;

FIG. 9 is a perspective view of an apparatus according to further embodiments of the invention with the holster disconnected from the armband holder;

FIG. 10 is a perspective view of an armband holder according to embodiments of the invention; and

FIG. 11 is a perspective view of a holster including a second connector, according to embodiments of the invention.

### DETAILED DESCRIPTION

The present invention now will be described more fully hereinafter with reference to the accompanying drawings, in which embodiments of the invention are shown. This invention should not be construed as limited to the embodiments set forth herein; rather, these embodiments are provided so that this disclosure will be thorough and complete, and will fully convey the scope of the invention to those skilled in the art. Like numbers refer to like elements throughout. Furthermore, the various features and regions illustrated in the figures are illustrated schematically. Accordingly, the present invention is not limited to the relative size and spacing illustrated in the accompanying figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

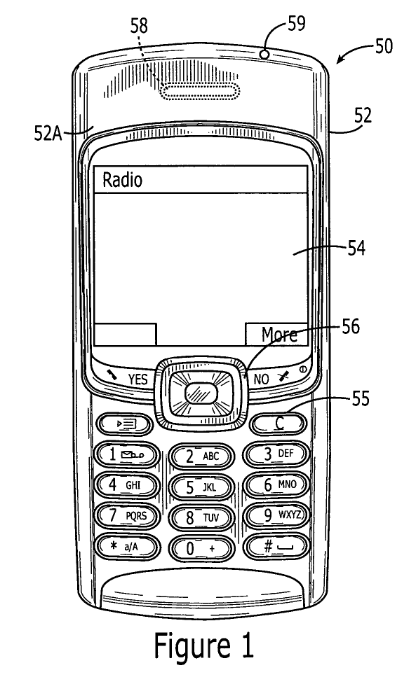

Embodiments of the present invention will now be described with reference to the schematic front view illustration of a personal electronic device, in particular, a wireless mobile terminal, in FIG. 1. FIG. 1 illustrates an exemplary mobile terminal 50 that may be used with a wireless communications network. The mobile terminal 50 includes a housing 52 having a front side 52A. A display screen 54 is positioned on the front side 52A of the mobile terminal 50, and a keypad 55 may be positioned on the front side 52A of the mobile terminal 50 adjacent the display 54. The mobile terminal 50 may additionally include optional ancillary control keys 56 for initiating/terminating operations of the mobile terminal 50. While not illustrated in FIG. 1, the mobile terminal 50 may include an optional flip member (not shown) rotatably connected to the portable housing 52 by a hinge (not shown). A display screen may be positioned on an inner and/or outer surface of the flip member.

An optional speaker 58 may be provided for the user to listen to audio output by the mobile terminal 50. The mobile terminal may additionally include an audio jack 59 for connecting an earphone and/or headphones (not shown) to the terminal 50.

Embodiments of the invention provide an apparatus for holding a portable electronic device, wherein the apparatus includes an integrated cable. The apparatus in some embodiments includes a portion configured to attach to a portable electronic device and a holding member which may be attached to the user's body. The holding member includes a first connector. A second connector that is configured to attach to the portable electronic device is further configured to releasably attach to the first connector. In some embodiments, the first connector and the second connector are generally circular in shape. At least one of the first connector and the second connector may be insertable into the other connector, and the other connector is configured to receive the at least one connector. At least one of the first connector and the second connector includes an integrated cable holder configured to hold, for example, a headphone cable that may be attached to a portable electronic device.

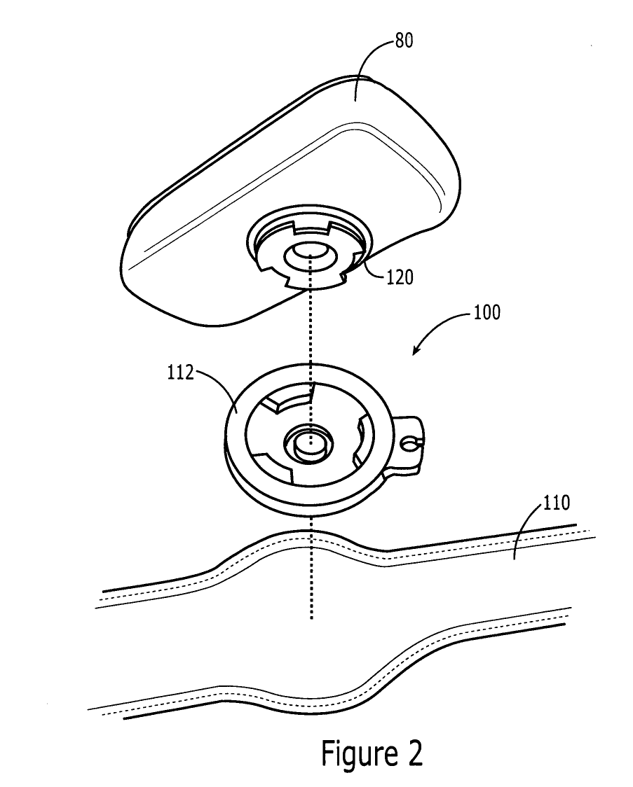

Referring to the embodiments of FIG. 2, an apparatus 100 according to embodiments of the invention is illustrated in exploded perspective view. The apparatus 100 includes a holding member 110, a first connector 112, and a second connector 120. The second connector 120 is configured to connect to a portable electronic device 80, which may include, for example, a mobile terminal. The first connector 112 may be affixed to the holding member 110. The second connector 120 is configured to be attached to the portable electronic device 80. As illustrated below, in some embodiments, the second connector may be affixed to a holster portion or retaining clip that is configured to receive and hold a portable electronic device 80. In other embodiments, the second connector may be detachably or permanently affixed to a portable electronic device 80.

The first and second connectors 112, 120 are further configured to releasably connect to each other. Accordingly, the portable electronic device 80 may be attached to and detached from the holding member 110 by connecting and disconnecting the first and second connectors 112, 120.

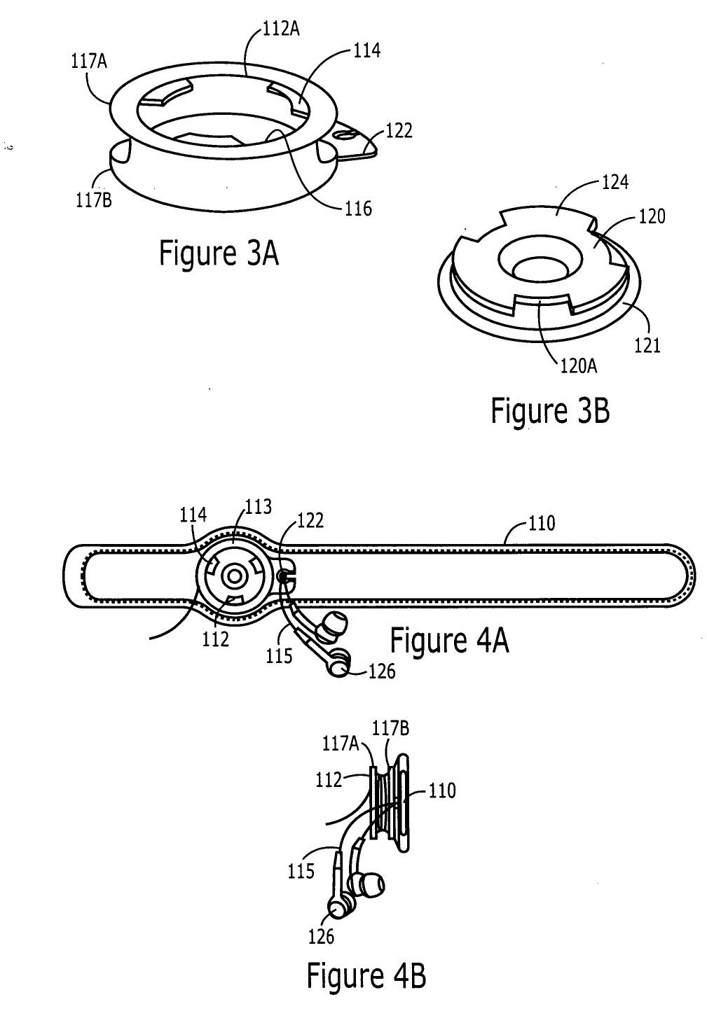

FIG. 3A is a perspective drawing showing additional details of a first connector 112 according to some embodiments of the invention. As illustrated in FIG. 3A, the first connector 112 may be generally cylindrical in shape having an inner surface 112A. In the embodiments illustrated in FIG. 3A, three retaining members 114 extend inwardly from an inner surface 112A of the generally cylindrical first connector 112. The retaining members 114 define three slots 116 between the three retaining members 114. The first connector 112 further includes a pair of circumferential lips 117A, 117B positioned at respective displaced ends of the generally cylindrical first connector 112.

FIG. 3B is a perspective drawing showing additional details of a second connector 120 according to some embodiments of the invention. As illustrated in FIG. 3B, the second connector 120 may be a generally cylindrical member having a base portion 121 at one end thereof. A plurality of tabs 124 may extend from an outer surface 120A of the generally cylindrical second connector 120.

Referring now to FIG. 4A, a holding member 110 and attached first connector 112 are illustrated in schematic front view. In the embodiments of FIG. 4A, the holding member 110 includes an armband that may be attached, for example, to a user's arm. The armband may be fabricated from a flexible material such as, for example, fabric-coated neoprene, which may comfortably fit around a user's arm. The armband may fasten around a user's arm by means of a Velcro® fastener, snap, button, and/or another type of fastener.

As illustrated in the embodiments of FIG. 4A, the holding member 110 includes a first connector 112, which in the embodiments illustrated in FIG. 4A is a generally cylindrical connector. The first connector 112 includes an integrated cable holder 113 which is configured to hold a cable 115. In particular, the cable holder 113 may include a spool defined by an outer circumference of the cylindrical first connector 112 together with circumferential lips 117A, 117B disposed at opposite ends thereof, as illustrated in FIG. 4B. In particular, the cable 115 may wrap around the cylindrical first connector 112 between the pair of circumferential lips 117A, 117B. The first connector 112 includes one or more inwardly-extending retaining members 114, which may be used to attach a second connector thereto, as described below.

As further illustrated in the embodiments of FIG. 4A, a pair of earbuds 126 may be attached at one end of the cable 115. In some embodiments, however, an adapter (not shown) may be attached at the one end of the cable 115 to permit other types of devices to be attached to the cable 115. The cable 115 may pass through a cable clip 122 which may extend from the first connector as illustrated in FIG. 4A. In some embodiments, the cable 115 may be wrapped by hand around the cable holder 113 and held in place at one end thereof by the cable clip 122. In other embodiments, the cable holder 113 may be spring-loaded such that, in use, the cable 115 may be automatically urged into the cable holder 113 and wound around the outer circumference of the cylindrical first connector. Spring-loaded retractable cable holders are generally known in the art and need not be described in detail. In some embodiments, the cable holder 113 may be configured to automatically latch into place when the cable is pulled by a user and then released. In other embodiments, the cable holder 113 may be configured to constantly urge the cable 115 into a retracted position. In such embodiments, the cable may be held in place at a desired extension by the cable clip 122.

A holding member 110 with an attached first connector 112 according to some embodiments of the invention is illustrated in schematic side view in FIG. 4B. As shown in the embodiments of FIG. 4B, the first connector 112 may have a generally cylindrical shape and may include a cable 115 wrapped on the outside of the connector 112. The cylindrical connector 112 may include a pair of lips 117A, 117B on respective front and back circumferential ends of the cylindrical connector 112. The lips 117A, 117B may help hold the cable 115 in place around the outside of the cylindrical first connector 112 as the cable 115 is wrapped/unwrapped and/or extended/retracted in use.

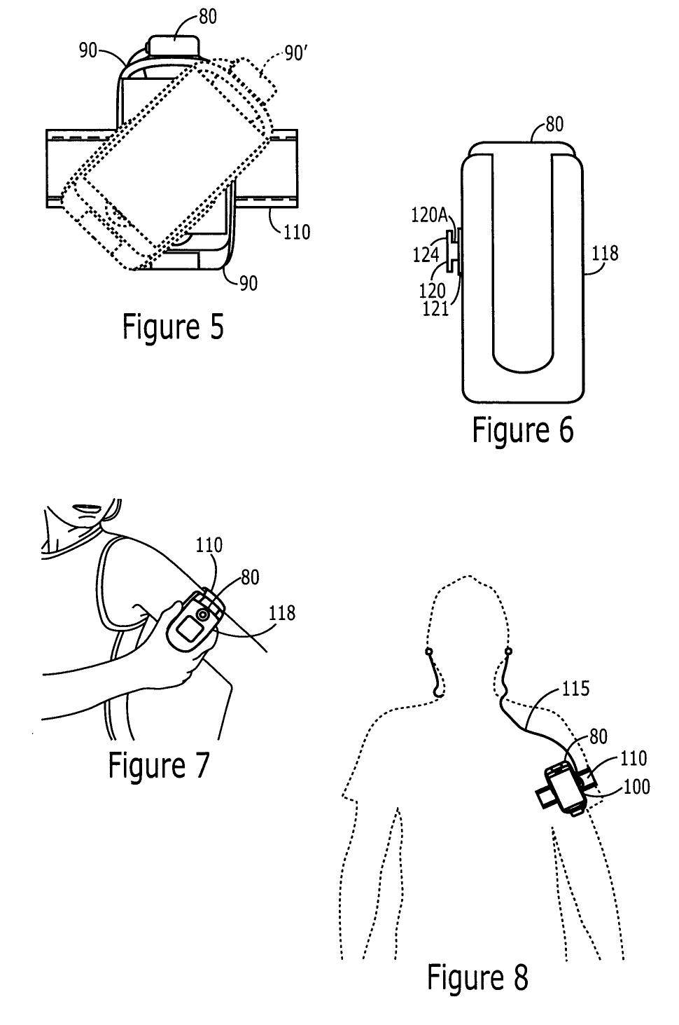

As illustrated in FIG. 5, a portable electronic device 80 on which a second connector (not shown) is affixed may be fastened to a holding member 110 on which a first connector (not shown) is affixed by placing the portable electronic device in a first radial orientation 90′ (indicated by broken lines) and inserting the second connector into the first connector. In the first radial orientation, tabs (not shown) extending from the second connector may align with slots (not shown) in the first connector, permitting the second connector to be inserted into the first connector. Once inserted, the portable electronic device 80 may be rotated into a second radial orientation 90, which in some embodiments may be rotated 600 from the first radial orientation. In the second radial orientation, tabs extending from the second connector may engage with retaining members (not shown) in the first connector which hold the second connector in place against longitudinal movement.

Referring to the embodiments of FIG. 6, a holster 118 for a portable electronic device 80 is illustrated. The holster 118 may be fabricated from a lightweight material, such as ABS plastic, fabric, and/or neoprene, that is strong enough to hold a portable electronic device. The second connector 120 may be affixed to the holster 118 via a base portion 121. In some embodiments, the second connector 120 may be formed integral with the holster 118. In some embodiments, the second connector 120 may be a generally cylindrical connector that is insertable into the first connector 112. In some embodiments, the outer diameter of the second connector 120 may be smaller than the inner diameter of the first connector 112 to permit the second connector 120 to be inserted into the first connector 112.

The second connector 120 may include one or more tabs 124 extending from an outer surface 120A of the second connector 120. The tabs 124 may cooperate with retaining members 114 on the first connector 112 (see FIG. 3A) to hold the holster 118 securely in place on the holding member 110. In some embodiments, the retaining members 114 may be positioned on the inside of the cylindrical connector 112, while the tabs 124 may be positioned on the outside of the second connector 120. Accordingly, when the second connector 120 is inserted into the first connector 112 in a first radial orientation and rotated to a second radial orientation, the tabs 124 on the second connector 120 may engage the retaining members 114 on the interior of the first connector 112 to thereby hold the holster 118 securely in place on the holding member 110.

Referring to the embodiments of FIGS. 2, 3A, 3B and 5, the holster 118 may be attached to the holding member 110 by placing the second connector 120 in contact with the first connector 112, and rotating the second connector 120 about a common central axis into a first axial orientation, i.e., until the tabs 124 slide past the retaining members 114 (i.e. until the tabs 124 align with spaces 116 between the retaining members 114 so that the second connector 120 slides into the first connector 112). The holster is then rotated into the second axial orientation, causing the tabs 124 to engage with the retaining members 114 and lock into place. In some embodiments, the first connector 112 includes three retaining members 114 extending inwardly from an inner surface thereof and arranged at spaced radial intervals to thereby define three spaces between the three retaining members 114, and the second connector 120 includes three tabs 124 extending outwardly from an outer surface thereof and arranged at spaced radial intervals such that the three tabs 124 may pass within the three spaces between the three retaining members 114 when the second connector 120 is inserted into the first connector 112.

As shown in FIG. 7, when the holding member 110 is affixed to a user's arm, the holster 118 having a portable electronic device 80 therein may be easily attached by the user to the holding member 110.

As illustrated in FIG. 8, according to some embodiments of the invention, when a portable electronic device 80 is attached to the user with an apparatus 100 according to embodiments of the present invention, the cable 115 extending from the holding member 110 to the user's ear may have little excess wire hanging behind or in front of the user when the cable is latched and/or clipped at a desired extension as described above.

While in some embodiments, the second connector 120 is insertable into the first connector 112, the first connector 112 could be insertable into the second connector 120. Furthermore, while the cable 115 is shown in the illustrated embodiments as held by the first connector 112 on the holding member 110, in some embodiments, the cable 115 may be held by the second connector 120 and/or on the holster 118.

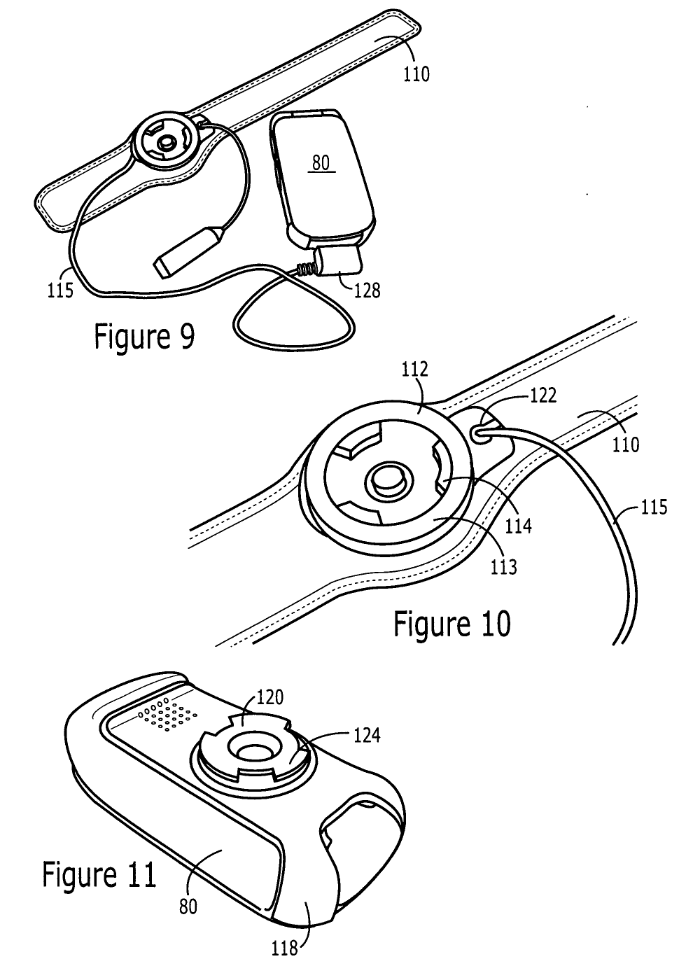

Referring to the embodiments of FIG. 9, the cable 115 may be connected to a portable electronic device 80, for example by means of a system connector 128 that is configured to attach to a corresponding connector (not shown) on the portable electronic device 80. The system connector 128 may be unique to a particular portable electronic device. Accordingly, in some embodiments, the cable 115 may include a universal connector, as for example a 2.5 mm audio connector, that may connect to a system connector adapter (not shown). In some embodiments, the cable 115 may be connected to a portable electronic device 80 by means of a 2.5 mm audio plug or other connector without using a system connector or a system connector adapter.

FIG. 10 is a perspective view of a first connector 112 on a holding member 110 according to some embodiments. As shown in FIG. 10, the cable 115 may pass upwards through a cable clip 122, which may hold the cable at a desired extension. In some embodiments, the cable clip 122 may help keep the cable 115 from becoming tangled as it is extended/retracted. In some embodiments, the cable 115 may be wrapped/unwrapped around the cable holder 113 by hand. In some embodiments, the cable 115 may retract into the cable holder 113 by means of an internal coil spring, as is known in the art.

The retaining members 114 are illustrated in FIG. 10 as extending inwardly from an interior circumferential surface 112A of the generally cylindrical first connector 112.

FIG. 11 is a perspective view of a second connector 120 on the holster 118. As illustrated in the embodiments of FIG. 11, the second connector 120 may include three tabs 124 that are configured to releasably engage the retaining members 114 on the interior of the first connector 112 (see FIG. 10) to thereby hold the portable electronic device 80 securely in place on a holding member 110. While the second connector 120 illustrated in FIG. 11 has three tabs 124, the second connector 120 may include more or fewer tabs. Other types of connectors and/or connection mechanisms may be provided.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. An apparatus for holding a portable electronic device and connecting the portable electronic device to an accessory, comprising:
a holding member including a first connector; and
a second connector configured to releasably attach to the first connector;
wherein the holding member or the second connector includes an integrated cable holder.

2. The apparatus of claim 1, wherein the first connector and the second connector are generally cylindrical in shape.

3. The apparatus of claim 2, wherein the second connector is insertable into the first connector.

4. The apparatus of claim 3, wherein the first connector has an inner diameter and the second connector has an outer diameter that is smaller than the inner diameter of the first connector, and wherein the first connector includes at least one retaining member extending inwardly from an inner surface thereof an defining at least one slot therein, and the second connector includes at least one tab extending outwardly from an outer surface thereof, such that when the first connector and the second connector are in a first radial orientation, the tab is configured to fit into the slot and when the first connector and the second connector are in a second radial orientation, the tab is held in place against longitudinal motion by the retaining member.

5. The apparatus of claim 5, wherein the first connector includes an integrated cable clip.

6. The apparatus of claim 5, wherein the cable holder comprises a cylinder having opposing ends and a pair of circumferential lips disposed at the opposing ends of the first connector such that a cable may be at least partially wrapped around the first connector between the pair of lips.

7. The apparatus of claim 1, further comprising a holster portion connected to the second connector and configured to receive the portable electronic device.

8. The apparatus of claim 1, wherein the second connector is configured to be attached directly to a portable electronic device.

9. The apparatus of claim 1, wherein the first connector is insertable into the second connector.

10. The apparatus of claim 9, wherein the second connector includes a retractable cable.

11. The apparatus of claim 1, wherein the cable holder includes an integrated retractable cable configured to connect to the portable electronic device.

12. The apparatus of claim 11, wherein the second connector has an inner diameter and the first connector has an outer diameter that is smaller than the inner diameter of the second connector, and wherein the second connector includes at least one retaining member extending inwardly from an inner surface thereof an defining at least one slot therein, and the first connector includes at least one tab extending outwardly from an outer surface thereof, such that when the first connector and the second connector are in a first radial orientation, the tab is configured to fit into the slot and when the first connector and the second connector are in a second radial orientation, the tab is held in place against longitudinal motion by the retaining member.

13. An apparatus for holding a portable electronic device, comprising:
an armband including a generally cylindrical first connector having an inner diameter and an outer diameter and having opposing ends and a pair of circumferential lips disposed at the opposing ends of the first connector such that a cable may be at least partially wound around the first connector between the pair of lips; and
a holder configured to hold the portable electronic device, the holder including a generally cylindrical second connector having an outer diameter smaller than the inner diameter of the first connector and configured to be insertable into the first connector and to releasably attach to the first connector.
wherein the first connector includes at least one retaining member extending inwardly from an inner surface thereof and the second connector includes at least one tab extending outwardly from an outer surface thereof that is configured to releasably engage the at least one retaining member.

14. The apparatus of claim 13, wherein the first connector includes three retaining members extending inwardly from an inner surface thereof and arranged at spaced radial intervals to thereby define three spaces between the three retaining members, and the second connector includes three tabs extending outwardly from an outer surface thereof and arranged at spaced radial intervals such that the three tabs may pass within the three spaces between the three retaining when the second connector is inserted into the first connector.

15. The apparatus of claim 13, wherein the holder configured to hold the portable electronic device comprises a holster.

16. The apparatus of claim 13, wherein the first connector includes an integrated retractable cable configured to connect to the portable electronic device.

17. An apparatus for holding a portable electronic device, comprising:
a holster portion configured to hold the portable electronic device, the holster portion including a generally cylindrical first connector having an inner diameter and an outer diameter and having opposing ends and a pair of circumferential lips disposed at the opposing ends of the first connector such that a cable may be at least partially wound around the first connector between the pair of lips; and
an armband including a generally cylindrical second connector having an outer diameter smaller than the inner diameter of the first connector and configured to be insertable into the first connector and to releasably attach to the first connector;
wherein the first connector includes at least one retaining member extending inwardly from an inner surface thereof and the second connector includes at least one tab extending outwardly from an outer surface thereof that is configured to releasably engage the at least one retaining member.

18. The apparatus of claim 17, wherein the first connector includes three retaining members extending inwardly from an inner surface thereof and arranged at spaced radial intervals to thereby define three spaces between the three retaining members, and the second connector includes three tabs extending outwardly from an outer surface thereof and arranged at spaced radial intervals such that the three tabs may pass within the three spaces between the three retaining members when the second connector is inserted into the first connector.

19. The apparatus of claim 17, wherein the first connector includes an integrated retractable cable configured to connect to the portable electronic device.
